(19) United States
(12) Patent Application Publication
(10) Pub. No.: US 2026/0111264 A1
(43) Pub. Date: Apr. 23, 2026

(54) SYSTEMS AND METHODS FOR USING SYNTHETIC DATASETS GENERATED FROM A PLURALITY OF SOURCE DATASETS TO DETERMINE A RESOURCE PROVISIONING CONFIGURATION OF A PLURALITY OF COMPUTING RESOURCES

(71) Applicant: Capital One Services, LLC, McLean, VA (US)

(72) Inventor: Taylor Turner, Richmond, VA (US)

(21) Appl. No.: 18/923,366

(22) Filed: Oct. 22, 2024

(51) Int. Cl. G06F 9/50

(52) U.S. Cl. CPC G06F 9/5005

(57) ABSTRACT

A system and a method include receiving, by at least one processor, a plurality of source datasets to be used by a source program executed by a plurality of computing resources. The plurality of source datasets is inputted to a source data profiling module that outputs a plurality of source data profiles. A synthetic data generator module is used to generate a plurality of synthetic datasets based at least in part on the plurality of source data profiles and/or the plurality of source datasets, where each synthetic dataset includes a matrix of synthetic data features. Based on a size of the matrix of synthetic data features for each of the plurality of synthetic datasets, a resource provisioning configuration profile is determined that utilizes the plurality of source datasets. The plurality of computing resources is provisioned using the resource provisioning configuration profile.

### FIELD OF TECHNOLOGY

The present disclosure generally relates to provisioning cloud computing resources and more specifically to improved computer-based systems and methods for using synthetic datasets to determine a resource provisioning configuration of a plurality of computing resources.

### BACKGROUND OF TECHNOLOGY

A computer network platform/system may include a group of computers (e.g., clients, servers, smart routers) and other computing hardware devices that are linked together through one or more communication channels to facilitate communication and/or resource-sharing, via one or more specifically programmed graphical user interfaces (GUIs) of the present disclosure, among a wide range of users.

### SUMMARY OF DESCRIBED SUBJECT MATTER

In some embodiments, the present disclosure provides an exemplary technically improved computer-based method that includes at least the following steps of receiving, by at least one processor, a plurality of source datasets to be used by at least one source program during an execution of the at least one source program by a plurality of computing resources. The plurality of source datasets may be inputted to a source data profiling module that is configured to respectively output a plurality of source data profiles for the plurality of source datasets, the plurality of source data profiles comprising metadata statistics for each of the plurality of source datasets. A synthetic data generator module may be utilized to generate a plurality of synthetic datasets based at least in part on the plurality of source data profiles, the plurality of source datasets, or both, each synthetic dataset from the plurality of synthetic datasets comprising a matrix of synthetic data features for each of the plurality of synthetic datasets based on the metadata statistics for each of the plurality of source datasets. Based on a size of the matrix of synthetic data features for each of the plurality of synthetic datasets, a resource provisioning configuration profile may be determined to facilitate the execution, by the plurality of computing resources, of the at least one source program that utilizes the plurality of source datasets. The plurality of computing resources may be provisioned based at least in part on the resource provisioning configuration profile.

In some embodiments, the present disclosure provides an exemplary technically improved computer-based system that includes at least the following components of at least one processor, and at least one transitory memory for storing software code. The at least one processor may be configured to execute the software code that causes the at least one processor to receive a plurality of source datasets to be used by at least one source program during an execution of the at least one source program by a plurality of computing resources; input the plurality of source datasets to a source data profiling module that is configured to respectively output a plurality of source data profiles for the plurality of source datasets, the plurality of source data profiles comprising metadata statistics for each of the plurality of source datasets; utilize a synthetic data generator module to generate a plurality of synthetic datasets based at least in part on the plurality of source data profiles, the plurality of source datasets, or both, each synthetic dataset from the plurality of synthetic datasets comprising a matrix of synthetic data features for each of the plurality of synthetic datasets based on the metadata statistics for each of the plurality of source datasets; determine based on a size of the matrix of synthetic data features for each of the plurality of synthetic datasets, a resource provisioning configuration profile to facilitate the execution, by the plurality of computing resources, of the at least one source program that utilizes the plurality of source datasets; and provision the plurality of computing resources based at least in part on the resource provisioning configuration profile.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram of a system for using synthetic datasets to determine a resource provisioning configuration of a plurality of computing resources in accordance with one or more embodiments of the present disclosure;

FIG. 2 is a flow diagram for generating a resource provisioning configuration profile in accordance with one or more embodiments of the present disclosure;

FIGS. 3A-3F are a first set of tables, a second set of tables, and a third set of tables showing three unique types of exemplary source datasets that may be used to determine a resource provisioning configuration of a plurality of computing resources in accordance with one or more embodiments of the present disclosure;

FIG. 4 is a flowchart of a method for using synthetic datasets to determine a resource provisioning configuration of a plurality of computing resources in accordance with one or more embodiments of the present disclosure;

FIG. 5 depicts a block diagram of an exemplary computer-based system/platform in accordance with one or more embodiments of the present disclosure;

FIG. 6 depicts a block diagram of another exemplary computer-based system/platform in accordance with one or more embodiments of the present disclosure; and

FIGS. 7 and 8 are diagrams illustrating implementations of cloud computing architecture/aspects with respect to which the disclosed technology may be specifically configured to operate, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of a software application.

At least some embodiments of the present disclosure herein disclose improved computer-based systems and methods for using synthetic datasets to determine a resource provisioning configuration of a plurality of computing resources. For a source code that may use a plurality of source datasets to be executed by a plurality of computing resources over a data pipeline, in one way in which to provision the plurality of computing resources to efficiently run the source code utilizing the plurality of source datasets in the data pipeline may not be known. On one hand, the plurality of computing resources may be under-provisioned such that the data pipeline job may not be able to run successfully on the plurality of computing resources. On the other hand, the plurality of computing resources may be over-provisioned, wasting resources that could be used for executing other computing tasks. Thus, at least one technical problem whereby the optimal resource configuration to provision the plurality of computing resources may be determined by trial-and-error through a rough guess and/or manual testing to determine the optimal resource provisioning configuration profile.

At least some embodiments of the systems and methods described herein may solve the at least one above identified technical problem by using both data profiling and synthetic data generated from the plurality of source datasets to quickly determine and may apply the most optimal resource configuration (e.g., a resource provisioning configuration) in which to automatically provision the plurality of computing resources tailored specifically for executing a specific source code utilizing a specific plurality of source datasets instead of estimating and/or manual testing provisioning requirements prior to actually running the full pipeline with the full dataset.

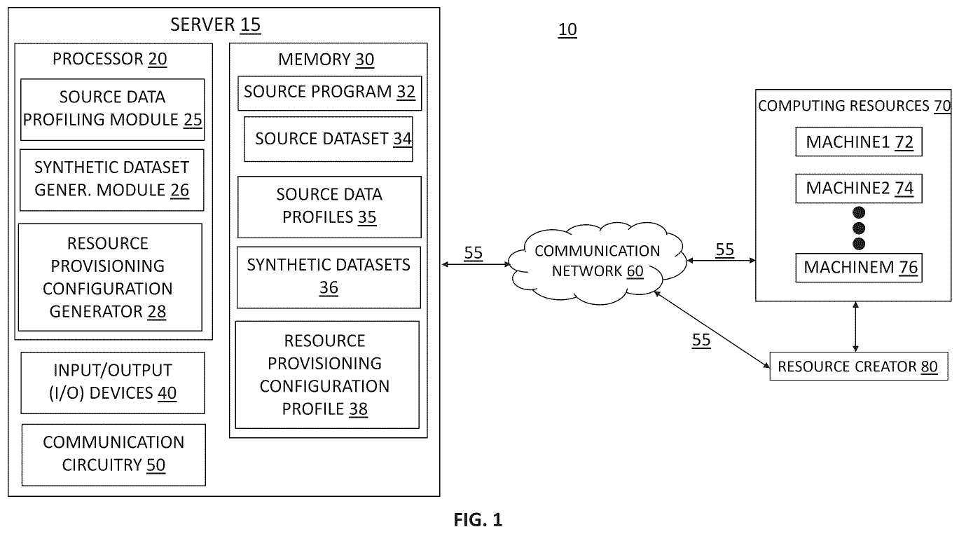

FIG. 1 is a block diagram of a system 10 for using synthetic datasets to determine a resource provisioning configuration of a plurality of computing resources in accordance with one or more embodiments of the present disclosure. The system 10 may include a server 15, a resource creator 80 and a plurality of computing resources 70 communicating 55 over a communication network 60.

In some embodiments, the server 15 may include at least one processor 20, at least one non-transient memory 30, at least one input and/or output (I/O) device 40, at least one communication circuitry 50 to facilitate communication 55 of the server 15 over the communication network 60 with the resource creator 80 and the plurality of computing resources 70.

In some embodiments, the at least one processor 20 may be configured to execute a number of software modules that may include a source data profiling module 25, a synthetic data generation module 26, and/or a resource provisioning configuration generator 28.

In some embodiments, the at least one non-transient memory 30 may be configured to store a source program code 32, a plurality of source dataset 34, a plurality of source data profiles generated by the source data profiling module 25, a plurality of synthetic datasets 36 generated by the synthetic data generation module 26, and/or a resource provisioning configuration profile 38 generated by the resource provisioning configuration generator 28.

In some embodiments, the plurality of computing resources 70 may include a plurality of M computing machines where M is an integer denoted MACHINE1 72, MACHINE2 74, . . . . MACHINEM 76 that may be configured to execute the source program 32 that utilizes the source dataset 34 after being provisioned using the resource provisioning configuration profile 38. Note that the term computing machine may include a computer, computing device, data processor, a virtual machine, and/or electronic computer.

In some embodiments, for the plurality of computing resources (not shown in FIG. 1) may refer any combination of hardware resources such as physical servers, storage devices, network equipment, software resources such as operating systems, applications, development tools, and/or cloud services resources such as virtual machines, storage, databases offered by cloud providers.

In some embodiments, the system 10 may be configured to provision the plurality of computing resources 70 to execute the source program 32 that utilizes the plurality of source datasets 34. The plurality of source datasets 34 may be big datasets (e.g., dataset sizes of terabytes, petabytes, or exabytes) that may be executed and stored on different computing machines (e.g., MACHINE1 72, MACHINE2 74, . . . . MACHINEM 76) the plurality of M computing machines of FIG. 1. Thus, distributing the tasks for executing the source program 32 using the plurality of datasets 34 over any of the plurality of computing resources 70 may result in the under-provisioning the computing resources, such as assigning too few machines to execute the task, or over-provisioning the computing resources, such as assigning too many machines to execute the task. This may be based for example on the dataset size of each dataset in the plurality of datasets.

In some embodiments, the provisioning of the plurality of computing resources may consider the workload or task that needs to be accomplished. Factors like processing power, memory, storage capacity, and network bandwidth for each of the computing machines may be all considered in the resource provisioning configuration profile 38 to configure each machine to function properly for executing the source code using the plurality of source datasets.

In some embodiments, the resource provisioning configuration profile 38 may include: (1) a choice of the type and/or quantity of machines from the plurality of computing resources, an installation of the necessary software and/or cloud service configurations, and/or machine configurations such as fine-tuning of settings to optimize performance and security. The resource provisioning configuration profile 38 may further account for scalability to easily add or remove resources (e.g., machines) so as to ensure a correct amount of computing power for fluctuating workloads, automation provisioning, and/or cost optimization to allocate resources efficiently to avoid over-provisioning (wasting resources) or under-provisioning (impacting performance).

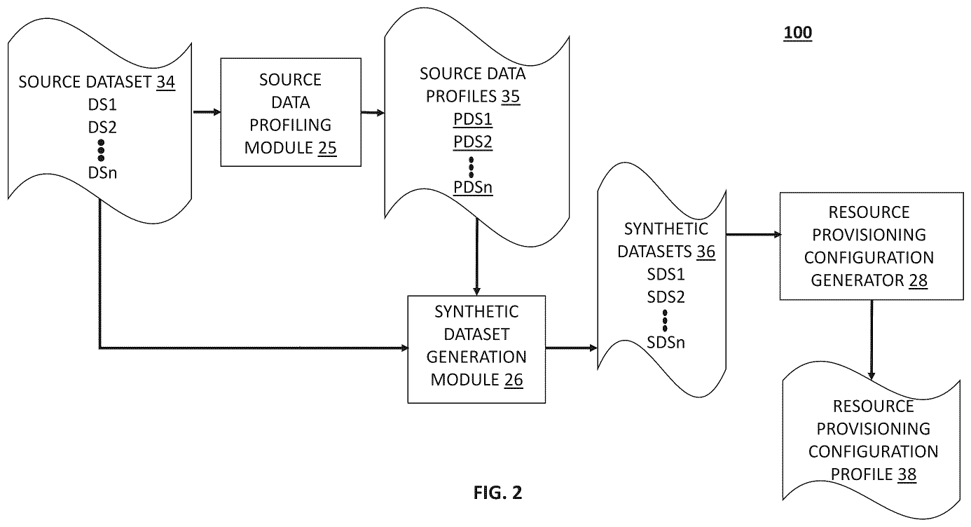

FIG. 2 is a flow diagram 100 for generating the resource provisioning configuration profile 38 in accordance with one or more embodiments of the present disclosure. The processor 20 may generate the resource provisioning configuration profile 38 as follows. First, the plurality of datasets 34 having n number of datasets denoted DS1, DS2, . . . . DSn where n is an integer, may be inputted into the source data profiling module 25. The source data profiling module 25 may generate a respective plurality of source data profiles 35 having n number of data profiles denoted PDS1, PDS2, . . . . PDSn where n is an integer. Each of the n source data profiles 35 may respectively include standardized metadata statistics for each of the n source datasets 34.

In some embodiments, the plurality of source data profiles 35 and/or the plurality of source datasets 34 may be inputted into a synthetic dataset generation module 26, which may output a plurality of synthetic datasets 36 having n number of synthetic datasets denoted SDS1, SDS2, . . . . SDSn where n is an integer. Each of the plurality of synthetic datasets 36 may include a matrix of synthetic dataset features including, for example, dataset sizes based on the metadata statistics for each of the plurality of source datasets 34.

In some embodiments, the matrix of synthetic dataset features of the plurality of synthetic datasets 36 may be used to simulate a runtime and/or memory usage profile known herein as the resource provisioning configuration profile 38 for running the source program 32 with the plurality of source datasets 34 by the plurality of computing resources 70.

In some embodiments, the plurality of synthetic datasets 36 may be inputted as shown in FIG. 2 into the resource provisioning configuration generator 28 to generate the resource provisioning configuration profile 38.

In some embodiments, the generation of the resource provisioning configuration profile 38 by the resource provisioning configuration generator 28 may be based in part on performing multiple test simulations using the plurality of synthetic datasets 36 to simulate the runtime and/or memory usage needs of the plurality of computing resources 70 for executing the at least one source program with the plurality of source datasets 34 in parallel runs across the plurality of M computing machines.

In some embodiments, the resource provisioning configuration profile 38 may be include a matrix of runtime and/or memory usage for each of the plurality of M computing machines running each of the plurality of synthetic datasets 36 in parallel runs so as to determine a final optimal configuration with the final CPU (central processing unit) and/or memory requirement for each of the plurality of M computing machines to execute the running the source program 32 with the plurality of source datasets 34.

In some embodiments, the synthetic dataset model generator module 26 may transform an original plurality of source datasets to a generated plurality of synthetic datasets. The generated plurality of synthetic datasets may mimic the statistical properties and/or data relationships of the original plurality of source datasets such that the full original datasets may not be needed for determining the resource provisioning configuration profile 38. The generated plurality of synthetic datasets may be used for estimating runtime and/or memory consumption for provisioning a set of computing resources from the plurality of computing resources assigned to executing at least one source program using the original plurality of source datasets without over-provisioning or under-provisioning the computing resources in the set.

In some embodiments, the computer code of the source program 32 may be large enough for the system 10 for consideration in determining the resource provisioning configuration profile 38 in addition to considering the plurality of source datasets 34 used by the source program 32.

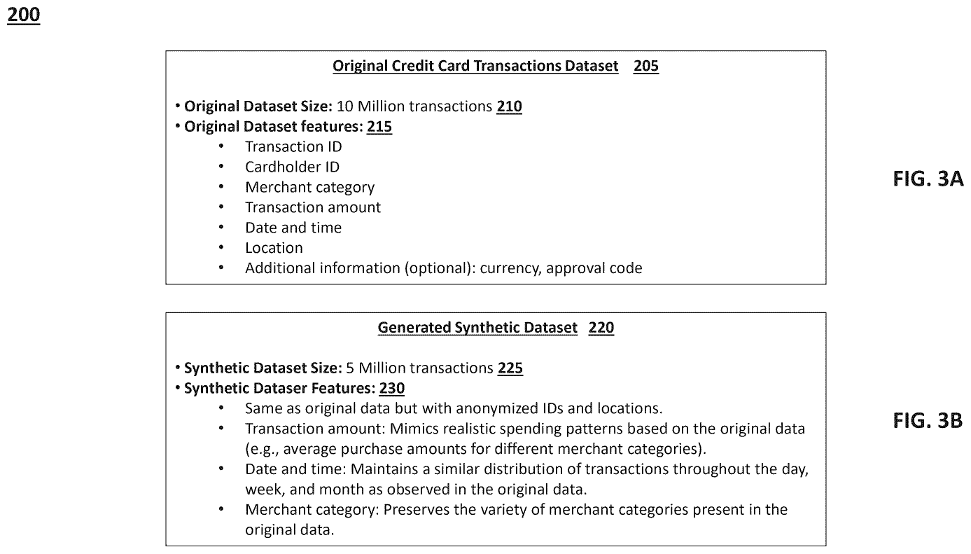

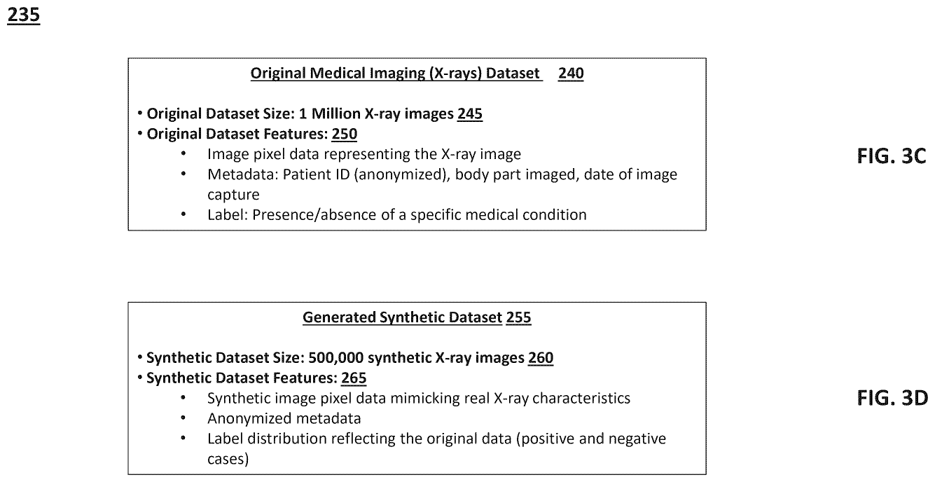

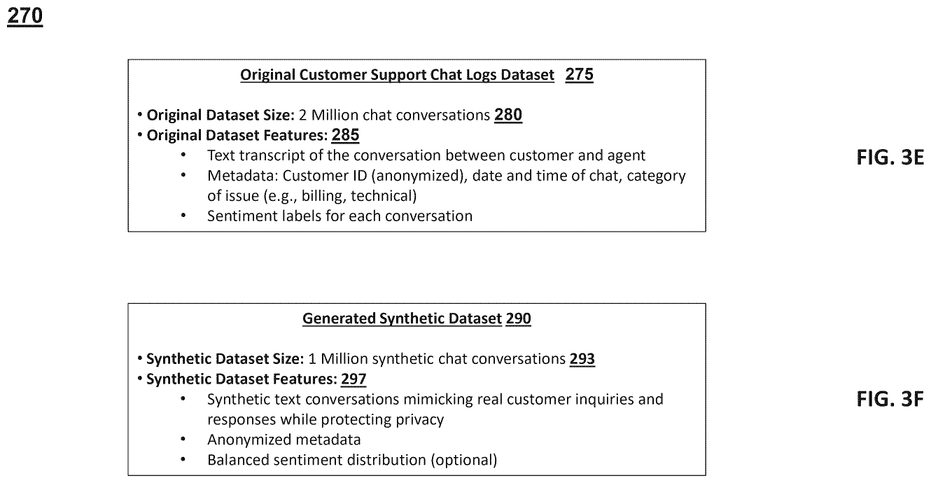

FIGS. 3A-3F are a first set 200 of tables, a second set 235 of tables, and a third set 270 of tables showing three unique types of exemplary source datasets that may be used to determine a resource provisioning configuration of a plurality of computing resources in accordance with one or more embodiments of the present disclosure. The exemplary datasets in FIGS. 3A-3F are shown here merely for conceptual and visual clarity, and not by way of limitation of the embodiments disclosed herein. Any type of source datasets may be used for the plurality of datasets 34.

For the first set 200 of tables, FIG. 3A shows an original credit card transactions dataset 205 that includes an original dataset size 210 and original dataset features 215. FIG. 3B shows a generated synthetic dataset 220 that includes a synthetic dataset size 225 and synthetic dataset features 230. The synthetic dataset model generator module 26 transformed the original credit card transactions dataset 205 to the generated synthetic dataset 220.

For the second set 235 of tables, FIG. 3C shows an original Medical Imaging (X-rays) dataset 240 that includes an original dataset size 245 and original dataset features 250. FIG. 3D shows a generated synthetic dataset 255 that includes a synthetic dataset size 260 and synthetic dataset features 265. The synthetic dataset model generator module 26 transformed original Medical Imaging (X-rays) dataset 240 to the generated synthetic dataset 255.

For the third set 270 of tables, FIG. 3E shows an original Customer Support Chat Logs dataset 275 that includes an original dataset size 280 and original dataset features 285. FIG. 3F shows a generated synthetic dataset 290 that includes a synthetic dataset size 293 and synthetic dataset features 297. The synthetic dataset model generator module 26 original Customer Support Chat Logs dataset 275 to the generated synthetic dataset 290.

In some embodiments, the matrix of synthetic dataset features in the plurality of synthetic datasets 36 may include synthetic dataset features such as the exemplary generated synthetic dataset features 230, 265, and 297 as well as the synthetic dataset sizes such as the exemplary synthetic dataset sizes 225, 260, and 293 as shown in FIGS. 3B, 3D, and 3F.

In some embodiments, the processor 20 may transmit over the communication network 60, an application programming interface (API) call to the resource creator 80 to provision the plurality of computing resources 70 based on the resource provisioning configuration profile 38 to execute the running the source program 32 with the plurality of source datasets 34, or stated differently, to provision each of the plurality of M computing machines to execute the running the source program 32 with the plurality of source datasets 34.

In some embodiments, the processor 20 may configure each of the plurality of M computing machines using load balancers.

In some embodiments, the resource provisioning configuration module 28 may determine an optimal configuration to provision each of the plurality of M computing machines based on the simulated resource demand during the real time execution of the code of the source program 32 using the plurality of datasets 34. The processor 20 may optimize the real time simulated resource demand by varying matrix elements in the matrix of synthetic data features, such as varying the number of matrix rows, the synthetic dataset features, or both to determine the resource provisioning configuration profile 38 to optimally provision in term of the most efficient runtime (CPU processing) and/or memory usage, each of the plurality of M computing machines to execute the running the source program 32 with the plurality of source datasets 34.

In some embodiments, the plurality of source datasets 34 may include a plurality of data rows and columns, such as on the order of millions or billions of rows, for example. The source data profiling module 25 may be configured to profile the source dataset 34 by generating metadata statistics on the source data. The profiling may include condensing all the data down into one column vector, for example, specifying a minimum value, a maximum value, a standard deviation, a distribution, and/or potential null values within the one column vector.

In some embodiments, the plurality of source datasets 34 may be structured or unstructured data.

In some embodiments, the source data profiling module 25 may generate natural language processing (NLP) statistics for all columns of the plurality of source datasets for condensing the data down to the most decision value-added metrics about the source data.

In some embodiments, the source data profiling module 25 may perturb the plurality of source datasets 34 to generate a plurality of perturbed synthetic datasets used to simulate the effect on runtime and/or memory usage when running the source program 32. The generation of the plurality of perturbed synthetic datasets may be based on the plurality of source datasets 34. One exemplary perturbation may be varying the number of rows, e.g., perturbed to have a hundred-thousand rows, a 10 million rows, or a thousand rows. Similarly, the dataset features of the source datasets may perturbed by assessing the effect on runtime and/or memory usage with 10 dataset features or a thousand dataset features, for example, when using the synthetic dataset generator 26 to generate the synthetic dataset from the perturbed source datasets. A determination of the resource provisioning configuration profile may be based on generating many different synthetic datasets that may perturb the original source datasets to assess the impact on runtime and/or memory usage in each of the plurality of M computing machines.

In some embodiments, the plurality of source datasets 34 may be in the form of a first set of matrices with a first order (e.g., n×m) and the plurality of synthetic datasets may be in the form of a second set of matrices with a second order (e.g., p×q), different from the first order, due to the perturbations of the source datasets to generate the synthetic dataset.

In some embodiments, the resource provisioning configure generator 28 may use the plurality of synthetic datasets 36 to identify at least one specific synthetic dataset feature from the plurality of synthetic dataset features that may need more computing resources (e.g., more computing machines) to execute the source program 32. In other embodiments, the need for more computing resources from the at least one specific synthetic dataset feature may be determined from the associated metadata statistics from the plurality of source data profiles 35.

In some embodiments, the resource provisioning configuration profile 38 may include a resource allocation table assigning a set of the plurality of M computing machines to execute the source program 32 with the plurality of source datasets 34.

In some embodiments, the resource provisioning configuration profile 38 may include a set of the plurality of M computing machines to execute the source program 32 with the plurality of source datasets 34 may include metrics such as for example, CPU load, memory load, elastic block store (EBS) volumes, and/or storage volumes for each of the plurality of M computing machines in the set.

In some embodiments, the processor 20 may generate multiple resource provisioning configuration profile 38 for provisioning multiple sets of the plurality of M computing machines to execute multiple source programs, each running a specific plurality of source datasets.

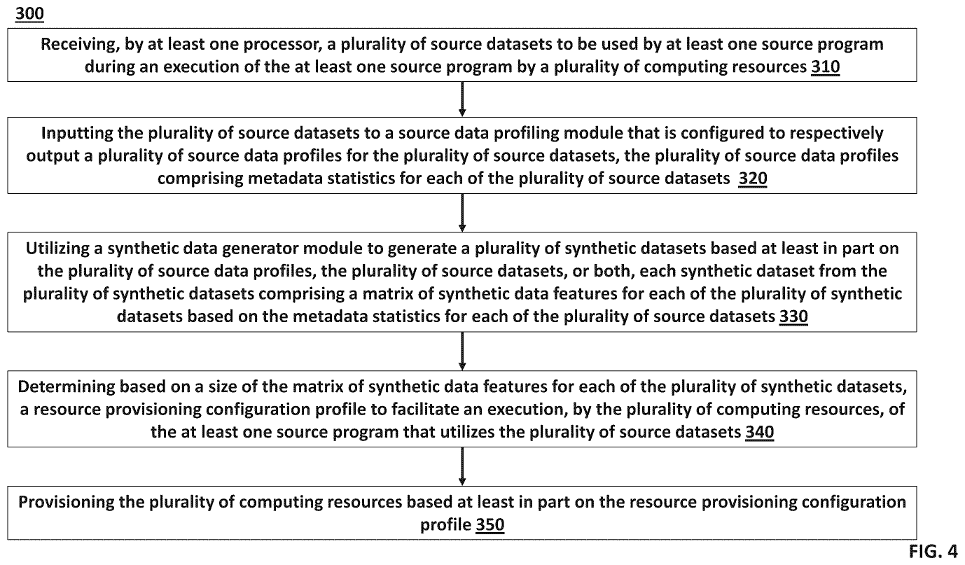

FIG. 4 is a flowchart of a method 300 for using synthetic datasets to determine a resource provisioning configuration of a plurality of computing resources in accordance with one or more embodiments of the present disclosure. The method 300 may be performed by the at least one processor 20 of the server 15.

In some embodiments, the method 300 may include receiving 310 a plurality of source datasets to be used by at least one source program during an execution of the at least one source program by a plurality of computing resources.

In some embodiments, the method 300 may include inputting 320 the plurality of source datasets to a source data profiling module that is configured to respectively output a plurality of source data profiles for the plurality of source datasets, the plurality of source data profiles comprising metadata statistics for each of the plurality of source datasets.

In some embodiments, the method 300 may include utilizing 330 a synthetic data generator module to generate a plurality of synthetic datasets based at least in part on the plurality of source data profiles, the plurality of source datasets, or both, each synthetic dataset from the plurality of synthetic datasets comprising a matrix of synthetic data features for each of the plurality of synthetic datasets based on the metadata statistics for each of the plurality of source datasets.

In some embodiments, the method 300 may include determining 340 based on a size of the matrix of synthetic data features for each of the plurality of synthetic datasets, a resource provisioning configuration profile to facilitate the execution, by the plurality of computing resources, of the at least one source program that utilizes the plurality of source datasets.

In some embodiments, the method 300 may include provisioning 350 the plurality of computing resources based at least in part on the resource provisioning configuration profile.

In some embodiments, exemplary inventive, specially programmed computing systems/platforms with associated devices may be configured to operate in a distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes. In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiments, this can enable NFC targets to take very simple form factors such as tags, stickers, key fobs, or cards that do not require batteries. In some embodiments, the NFC's peer-to-peer communication can be conducted when a plurality of NFC-enabled devices (e.g., smartphones) are within close proximity of each other.

The material disclosed herein may be implemented in software or firmware or a combination of them or as instructions stored on a machine-readable medium, which may be read and executed by one or more processors (e.g., the processor 20). A machine-readable medium may include any medium and/or mechanism for storing or transmitting information in a form readable by a machine (e.g., the server 15). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, in at least some embodiments, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

As used herein, in at least some embodiments, the term “module” should be understood to refer to specifically programmed computer hardware (e.g., chip, circuitry, etc.) executing specialized computer instructions/code or a compilation of computer program routines configured to perform specialized function(s) and that may at least partially reside in a non-transitory computer medium when not being executed by a computing device.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD, NetBSD, OpenBSD; (2) Linux; (3) Microsoft Windows; (4) OS X (MacOS); (5) MacOS 11; (6) Solaris; (7) Android; (8) iOS; (9) Embedded Linux; (10) Tizen; (11) WebOS; (12) IBM i; (13) IBM AIX; (14) Binary Runtime Environment for Wireless (BREW); (15) Cocoa (API); (16) Cocoa Touch; (17) Java Platforms; (18) JavaFX; (19) JavaFX Mobile; (20) Microsoft DirectX; (21).NET Framework; (22) Silverlight; (23) Open Web Platform; (24) Oracle Database; (25) Qt; (26) Eclipse Rich Client Platform; (27) SAP NetWeaver; (28) Smartface; and/or (29) Windows Runtime.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices, and/or exemplary inventive computer-based components of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

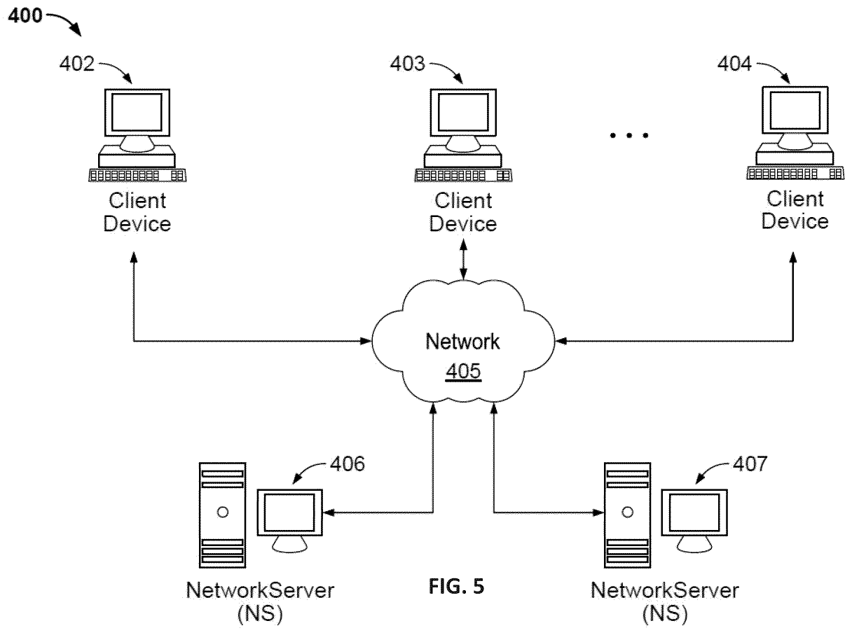

FIG. 5 depicts a block diagram of an exemplary computer-based system/platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 400 may be configured to manage a large number of members and/or concurrent transactions, as detailed herein. In some embodiments, the exemplary computer-based system/platform 400 may be based on a scalable computer and/or network architecture that incorporates various strategies for assessing the data, caching, searching, and/or database connection pooling. An example of the scalable architecture is an architecture that is capable of operating multiple servers.

In some embodiments, referring to FIG. 5, members 402-404 (e.g., clients) of the exemplary computer-based system/platform 400 may include virtually any computing device capable of receiving and sending a message over a network (e.g., cloud network), such as network 405, to and from another computing device, such as servers 406 and 407, each other, and the like. In some embodiments, the member devices 402-404 may be personal computers, multiprocessor systems, microprocessor-based or programmable consumer electronics, network PCs, and the like. In some embodiments, one or more member devices within member devices 402-404 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java, .Net, QT, C, C++ and/or other suitable programming language. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine readable media.

In some embodiments, the exemplary server 406 or the exemplary server 407 may be a web server (or a series of servers) running a network operating system, examples of which may include but are not limited to Microsoft Windows Server, Novell NetWare, or Linux. In some embodiments, the exemplary server 406 or the exemplary server 407 may be used for and/or provide cloud and/or network computing. Although not shown in FIG. 5, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 401-404.

In some embodiments and, optionally, in combination of any embodiment described above or below, for example, one or more exemplary computing member devices 402-404, the exemplary server 406, and/or the exemplary server 407 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

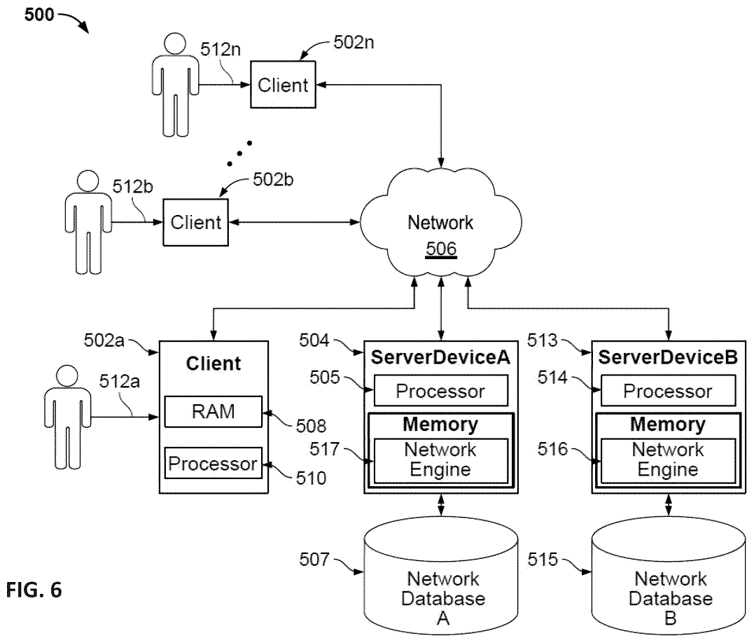

FIG. 6 depicts a block diagram of another exemplary computer-based system/platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 502a, 502b thru 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of member computing device 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices (e.g., the I/O devices 40) such as a mouse, a CD-ROM, DVD, a physical or virtual keyboard, a display, a speaker, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™, Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, users, 512a through 512n, may communicate over the exemplary network 506 with each other and/or with other systems and/or devices coupled to the network 506. As shown in FIG. 6, exemplary server devices 504 and 513 may be also coupled to the network 506. In some embodiments, one or more member computing devices 502a through 502n may be mobile clients.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

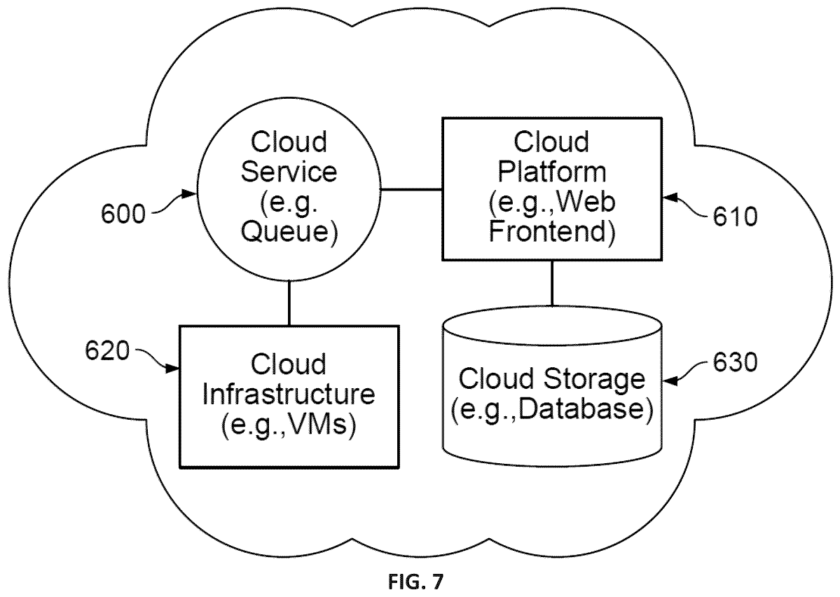

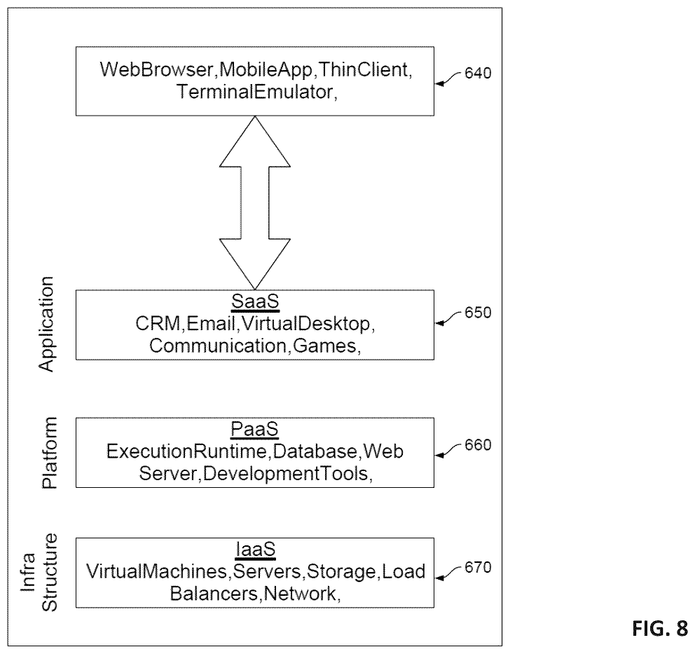

In some embodiments, the exemplary inventive computer-based systems/platforms, the exemplary inventive computer-based devices, and/or the exemplary inventive computer-based components of the present disclosure may be specifically configured to operate in an cloud computing/architecture such as, but not limiting to: infrastructure a service (IaaS), platform as a service (PaaS), and/or software as a service (SaaS). FIGS. 7 and 8 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

At least some aspects of the present disclosure will now be described with reference to the following numbered clauses:
1. A method may include receiving, by at least one processor, a plurality of source datasets to be used by at least one source program during an execution of the at least one source program by a plurality of computing resources; inputting, by the at least one processor, the plurality of source datasets to a source data profiling module that is configured to respectively output a plurality of source data profiles for the plurality of source datasets, the plurality of source data profiles comprising metadata statistics for each of the plurality of source datasets; utilizing, by the at least one processor, a synthetic data generator module to generate a plurality of synthetic datasets based at least in part on the plurality of source data profiles, the plurality of source datasets, or both, each synthetic dataset from the plurality of synthetic datasets comprising a matrix of synthetic data features for each of the plurality of synthetic datasets based on the metadata statistics for each of the plurality of source datasets; determining, by the at least one processor, based at least in part on a size of the matrix of the synthetic data features for each of the plurality of synthetic datasets, a resource provisioning configuration profile to facilitate the execution, by the plurality of computing resources, of the at least one source program that utilizes the plurality of source datasets; and provisioning, by the at least one processor, the plurality of computing resources based at least in part on the resource provisioning configuration profile.
2. The method according to clause 1, where the provisioning of the plurality of computing resources may include transmitting over a communication network, an application programming interface (API) call to a resource creator configured to provision the plurality of computing resources based on the resource provisioning configuration profile.
3. The method according to clause 1, where the provisioning of the plurality of computing resources may include assigning a set of computing resources from the plurality of computing resources to execute the at least one source program.
4. The method according to clause 1, where the plurality of computing resources may include a plurality of computing machines.
5. The method according to clause 4, where the provisioning of the plurality of computing resources may include assigning a set of the plurality of computing machines to execute the at least one source program in accordance with a resource allocation table.
6. The method according to clause 4, where the determining the resource provisioning configuration profile may include performing multiple test simulations using the plurality of synthetic datasets to simulate runtime metrics, memory usage metrics, or both for executing the at least one source program with the plurality of source datasets in parallel runs across the plurality of computing machines.
7. The method according to clause 1, where the determining of the resource provisioning configuration profile may include varying matrix elements in the matrix of the synthetic data features.
8. The method according to clause 7, where the varying of matrix elements in the matrix of the synthetic data features may include varying a number of matrix rows, the synthetic data features, or both.
9. The method according to clause 1, where the determining of the resource provisioning configuration profile may include identifying at least one specific synthetic data feature from the synthetic data features needing more computing resources to execute the at least one source program.
10. The method according to clause 1, may further include perturbing, by the at least one processor, data in the plurality of source datasets to respectively generate a plurality of perturbed synthetic datasets; and where the determining of the resource provisioning configuration profile may include simulating runtime metrics, memory usage metrics, or both for the plurality of computing resources using the plurality of perturbed synthetic datasets for executing the at least one source program.
11. A computer-based system may include at least one processor, and at least one transitory memory for storing software code. The at least one processor may be configured to execute the software code that causes the at least one processor to receive a plurality of source datasets to be used by at least one source program during an execution of the at least one source program by a plurality of computing resources; input the plurality of source datasets to a source data profiling module that is configured to respectively output a plurality of source data profiles for the plurality of source datasets, the plurality of source data profiles comprising metadata statistics for each of the plurality of source datasets; utilize a synthetic data generator module to generate a plurality of synthetic datasets based at least in part on the plurality of source data profiles, the plurality of source datasets, or both, each synthetic dataset from the plurality of synthetic datasets comprising a matrix of synthetic data features for each of the plurality of synthetic datasets based on the metadata statistics for each of the plurality of source datasets; determine based at least in part on a size of the matrix of the synthetic data features for each of the plurality of synthetic datasets, a resource provisioning configuration profile to facilitate the execution, by the plurality of computing resources, of the at least one source program that utilizes the plurality of source datasets; and provision the plurality of computing resources based at least in part on the resource provisioning configuration profile.
12. The computer-based system according to clause 11, where the at least one processor may be configured to provision the plurality of computing resources by transmitting over a communication network, an application programming interface (API) call to a resource creator configured to provision the plurality of computing resources based on the resource provisioning configuration profile.
13. The computer-based system according to clause 11, where the at least one processor may be configured to provision the plurality of computing resources by assigning a set of computing resources from the plurality of computing resources to execute the at least one source program.
14. The computer-based system according to clause 11, where the plurality of computing resources may include a plurality of computing machines.
15. The computer-based system according to clause 14, where the at least one processor may be configured to provision the plurality of computing resources by assigning a set of the plurality of computing machines to execute the at least one source program in accordance with a resource allocation table.
16. The computer-based system according to clause 14, where the at least one processor may be configured to determine the resource provisioning configuration profile by performing multiple test simulations using the plurality of synthetic datasets to simulate runtime metrics, memory usage metrics, or both for executing the at least one source program with the plurality of source datasets in parallel runs across the plurality of computing machines.
17. The computer-based system according to clause 11, where the at least one processor may be configured to determine the resource provisioning configuration profile by varying matrix elements in the matrix of the synthetic data features.
18. The computer-based system according to clause 11, where the at least one processor may be configured to determine the resource provisioning configuration profile by identifying at least one specific synthetic data feature from the synthetic data features needing more computing resources to execute the at least one source program.
19. The computer-based system according to clause 11, where the at least one processor may be further configured to perturb data in the plurality of source datasets to respectively generate a plurality of perturbed synthetic datasets; and where the at least one processor may be configured to determine the resource provisioning configuration profile by simulating runtime metrics, memory usage metrics, or both for the plurality of computing resources using the plurality of perturbed synthetic datasets for executing the at least one source program.
20. A computer-based system may include a means to receive a plurality of source datasets to be used by at least one source program; a means to output a plurality of source data profiles for the plurality of source datasets comprising metadata statistics for each of the plurality of source datasets; a means to generate a plurality of synthetic datasets based at least in part on the plurality of source data profiles, the plurality of source datasets, or both, each synthetic dataset from the plurality of synthetic datasets comprising a matrix of synthetic data features for each of the plurality of synthetic datasets based on the metadata statistics for each of the plurality of source datasets; a means to determine based on a size of the matrix of synthetic data features for each of the plurality of synthetic datasets, a resource provisioning configuration profile to facilitate an execution, by a plurality of computing resources, of the at least one source program that utilizes the plurality of source datasets; and a means to provision the plurality of computing resources based at least in part on the resource provisioning configuration profile.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

1. A method, comprising:
receiving, by at least one processor, a plurality of source datasets to be used by at least one source program during an execution of the at least one source program by a plurality of computing resources;
inputting, by the at least one processor, the plurality of source datasets to a source data profiling module that is configured to respectively output a plurality of source data profiles for the plurality of source datasets, the plurality of source data profiles comprising metadata statistics for each of the plurality of source datasets;
utilizing, by the at least one processor, a synthetic data generator module to generate a plurality of synthetic datasets based at least in part on the plurality of source data profiles, the plurality of source datasets, or both, each synthetic dataset from the plurality of synthetic datasets comprising a matrix of synthetic data features for each of the plurality of synthetic datasets based on the metadata statistics for each of the plurality of source datasets;
determining, by the at least one processor, based at least in part on a size of the matrix of the synthetic data features for each of the plurality of synthetic datasets, a resource provisioning configuration profile to facilitate the execution, by the plurality of computing resources, of the at least one source program that utilizes the plurality of source datasets; and
provisioning, by the at least one processor, the plurality of computing resources based at least in part on the resource provisioning configuration profile.

2. The method according to claim 1, wherein the provisioning of the plurality of computing resources comprises transmitting over a communication network, an application programming interface (API) call to a resource creator configured to provision the plurality of computing resources based on the resource provisioning configuration profile.

3. The method according to claim 1, wherein the provisioning of the plurality of computing resources comprises assigning a set of computing resources from the plurality of computing resources to execute the at least one source program.

4. The method according to claim 1, wherein the plurality of computing resources comprises a plurality of computing machines.

5. The method according to claim 4, wherein the provisioning of the plurality of computing resources comprises assigning a set of the plurality of computing machines to execute the at least one source program in accordance with a resource allocation table.

6. The method according to claim 4, wherein the determining the resource provisioning configuration profile comprises performing multiple test simulations using the plurality of synthetic datasets to simulate runtime metrics, memory usage metrics, or both for executing the at least one source program with the plurality of source datasets in parallel runs across the plurality of computing machines.

7. The method according to claim 1, wherein the determining of the resource provisioning configuration profile comprises varying matrix elements in the matrix of the synthetic data features.

8. The method according to claim 7, wherein the varying of matrix elements in the matrix of the synthetic data features comprises varying a number of matrix rows, the synthetic data features, or both.

9. The method according to claim 1, wherein the determining of the resource provisioning configuration profile comprises identifying at least one specific synthetic data feature from the synthetic data features needing more computing resources to execute the at least one source program.

10. The method according to claim 1, further comprising perturbing, by the at least one processor, data in the plurality of source datasets to respectively generate a plurality of perturbed synthetic datasets; and
wherein the determining of the resource provisioning configuration profile comprises simulating runtime metrics, memory usage metrics, or both for the plurality of computing resources using the plurality of perturbed synthetic datasets for executing the at least one source program.

11. A computer-based system, comprising:
at least one processor, and
at least one transitory memory for storing software code;
wherein the at least one processor is configured to execute the software code that causes the at least one processor to:
receive a plurality of source datasets to be used by at least one source program during an execution of the at least one source program by a plurality of computing resources;
input the plurality of source datasets to a source data profiling module that is configured to respectively output a plurality of source data profiles for the plurality of source datasets, the plurality of source data profiles comprising metadata statistics for each of the plurality of source datasets;
utilize a synthetic data generator module to generate a plurality of synthetic datasets based at least in part on the plurality of source data profiles, the plurality of source datasets, or both, each synthetic dataset from the plurality of synthetic datasets comprising a matrix of synthetic data features for each of the plurality of synthetic datasets based on the metadata statistics for each of the plurality of source datasets;
determine based at least in part on a size of the matrix of the synthetic data features for each of the plurality of synthetic datasets, a resource provisioning configuration profile to facilitate the execution, by the plurality of computing resources, of the at least one source program that utilizes the plurality of source datasets; and
provision the plurality of computing resources based at least in part on the resource provisioning configuration profile.

12. The computer-based system according to claim 11, wherein the at least one processor is configured to provision the plurality of computing resources by transmitting over a communication network, an application programming interface (API) call to a resource creator configured to provision the plurality of computing resources based on the resource provisioning configuration profile.

13. The computer-based system according to claim 11, wherein the at least one processor is configured to provision the plurality of computing resources by assigning a set of computing resources from the plurality of computing resources to execute the at least one source program.

14. The computer-based system according to claim 11, wherein the plurality of computing resources comprises a plurality of computing machines.

15. The computer-based system according to claim 14, wherein the at least one processor is configured to provision the plurality of computing resources by assigning a set of the plurality of computing machines to execute the at least one source program in accordance with a resource allocation table.

16. The computer-based system according to claim 14, wherein the at least one processor is configured to determine the resource provisioning configuration profile by performing multiple test simulations using the plurality of synthetic datasets to simulate runtime metrics, memory usage metrics, or both for executing the at least one source program with the plurality of source datasets in parallel runs across the plurality of computing machines.

17. The computer-based system according to claim 11, wherein the at least one processor is configured to determine the resource provisioning configuration profile by varying matrix elements in the matrix of the synthetic data features.

18. The computer-based system according to claim 11, wherein the at least one processor is configured to determine the resource provisioning configuration profile by identifying at least one specific synthetic data feature from the synthetic data features needing more computing resources to execute the at least one source program.

19. The computer-based system according to claim 11, wherein the at least one processor is further configured to perturb data in the plurality of source datasets to respectively generate a plurality of perturbed synthetic datasets; and
wherein the at least one processor is configured to determine the resource provisioning configuration profile by simulating runtime metrics, memory usage metrics, or both for the plurality of computing resources using the plurality of perturbed synthetic datasets for executing the at least one source program.

20. A computer-based system, comprising:
a means to receive a plurality of source datasets to be used by at least one source program;
a means to output a plurality of source data profiles for the plurality of source datasets comprising metadata statistics for each of the plurality of source datasets;
a means to generate a plurality of synthetic datasets based at least in part on the plurality of source data profiles, the plurality of source datasets, or both, each synthetic dataset from the plurality of synthetic datasets comprising a matrix of synthetic data features for each of the plurality of synthetic datasets based on the metadata statistics for each of the plurality of source datasets;
a means to determine based on a size of the matrix of synthetic data features for each of the plurality of synthetic datasets, a resource provisioning configuration profile to facilitate an execution, by a plurality of computing resources, of the at least one source program that utilizes the plurality of source datasets; and
a means to provision the plurality of computing resources based at least in part on the resource provisioning configuration profile.
